(19) United States
(12) Patent Application Publication
(10) Pub. No.: US 2006/0013002 A1
(43) Pub. Date: Jan. 19, 2006

(54) Light emitting diode disc optic with heat sink housing

(75) Inventors: Charles M. Coushaine, Rindge, NH (US); Michael Tucker, Henniker, NH (US); Thomas Tessnow, Weare, NH (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 10/939,013

(22) Filed: Sep. 10, 2004

Related U.S. Application Data
(60) Provisional application No. 60/588,471, filed on Jul. 16, 2004.

(51) Int. Cl. F21V 7/00

(52) U.S. Cl. 362/308; 362/294; 362/800

(57) ABSTRACT

A lamp (10) has a cup-shaped body (12) with a bottom (14) with a sidewall (16) defining a top (18). The body (12) is thermally conductive. A reflective coating (20) is provided on the inside surface bottom (14) and side wall (16) for reflecting light from a side emitting LED (22) that is mounted on a thermally conductive, electrically insulating coupling (24) and is centered on the bottom (14). A lens (26) for directing light emitted from the LED (22) in a desired direction is provided and preferably is a Fresnel optic. The lens (26) can close the opening (18) or it can be formed as an integral part of bottom (14) or it can be added to the bottom (14). Alternatively, the lens (26) can be solid with the lens elements either external or internal. Electrical connections (28, 30) to the LED extend through the cup-shaped body (14).

This application claims priority from Provisional Patent Application No. 60/588,471, filed Jul. 16, 2004.

### TECHNICAL FIELD

This invention relates to light sources and more particularly to light sources employing light emitting diodes (LED or LEDs) and more particularly to light sources useful in the automotive field such as for headlights, taillights, stoplights, fog lights, turn signals, etc.

### BACKGROUND ART

In the past, most automotive light sources have involved the use of incandescent bulbs. While working well and being inexpensive, these bulbs have a relatively short life and, of course, the thin filament employed was always subject to breakage due to vibration.

LEDs are solid state light sources and have achieved recent gains in usage because of their long life; however, it has been found that driving LEDs at the power required for automotive uses generates a considerable amount heat requiring rather elaborate heat sinks for efficient operation.

Accordingly, it would be an advance in the art to simplify heat sinking in LEDs, particularly those for use in automotive applications.

### DISCLOSURE OF INVENTION

It is, therefore, an object of the invention to obviate the disadvantages of the prior art.

It is another object of the invention to enhance LED light sources.

These objects are accomplished, in one aspect of the invention, by a lamp comprising a cup-shaped body having a planar bottom with an up-standing, peripheral side wall defining a top, a reflective coating on an inside surface of the planar bottom and side wall, a single, side emitting LED mounted on a thermally conductive coupling positioned substantially in the center of the planar bottom, a lens for directing a beam of light emitted from the LED in a desired direction, and electrical connections to the LED extending through the cup-shaped body.

In a preferred embodiment of the invention the cup-shaped body is thermally conductive thus eliminating the need for extra heat sinking.

### BRIEF DESCRIPTION OF THE DRAWINGS

FIG. 1 is a diagrammatic sectional view of an embodiment of the invention;

FIG. 2 is a diagrammatic sectional view of an alternate embodiment of the invention;

FIG. 3 is a diagrammatic sectional view of yet another embodiment of the invention;

FIG. 4 is a diagrammatic view of yet another embodiment of the invention; and

FIG. 5 is a diagrammatic view of still another embodiment of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

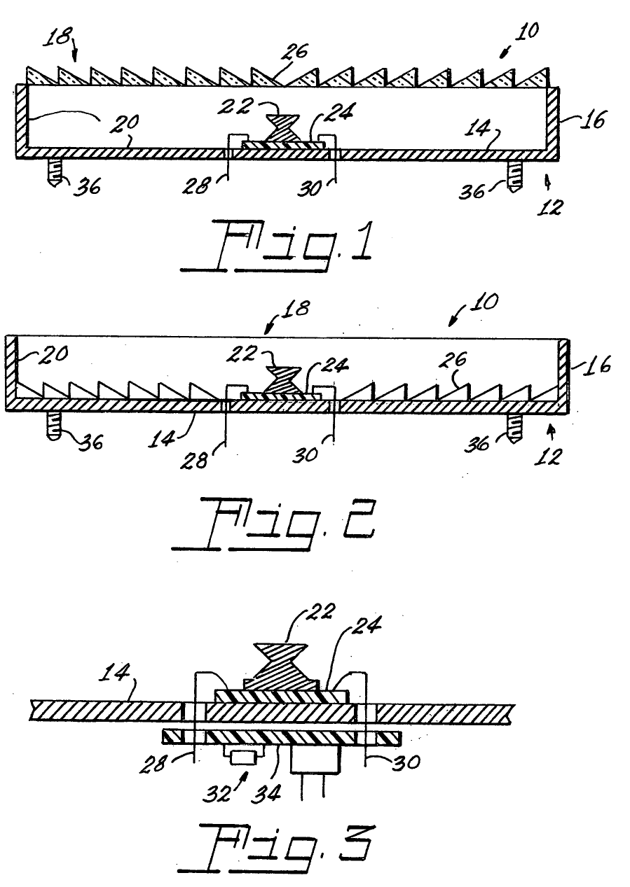

Referring now to the drawings with greater particularity, there is shown in FIG. 1 a lamp 10 having a cup-shaped body 12 with a planar bottom 14 with an up-standing, peripheral sidewall 16 defining a top 18.

The body 12 is thermally conductive and preferably is a metal such as aluminum. A reflective coating 20 is provided on the inside surface of the planar bottom 14 and side wall 16 for reflecting light generated by a single, side emitting LED 22 that is mounted on a thermally conductive, electrically insulating coupling 24 and is positioned substantially in the center of the planar bottom 14.

A lens 26 for directing a beam of light emitted from the LED 22 in a desired direction is provided and preferably is a Fresnel optic. The lens 26 can close the opening 18 as shown in FIG. 1 or it can be formed as an integral part of bottom 14 or it can be added to the bottom 14, as shown in FIG. 2. Alternatively, the lens 26 can be solid with the lens elements external as shown in FIG. 4 or internal as shown in FIG. 5. Electrical connections 28, 30 to the LED extend through the cup-shaped body 14.

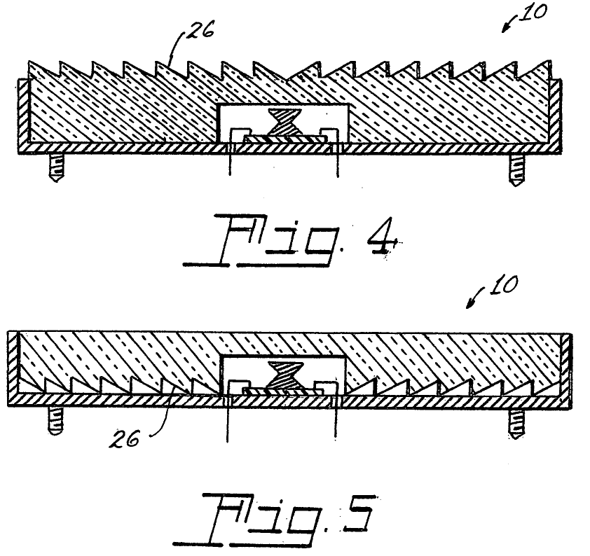

Controlled power can be provided to the LED through circuitry 32, for example, on a printed circuit board 34. The board 34 can be positioned within the cavity formed by the body 14 and the lens 26, when the lens 26 closes opening 18, or it can be positioned externally of the body 12 as shown in FIG. 3. A connector 38 for connection to a power source can also be provided.

Mountings for the lamp 10, such as threaded studs 36, can be provided on the body 12 if desired.

All of the embodiments shown and described provide a flat package with a single LED.

While there have been shown and described what are present considered to be the preferred embodiments of the invention, it will be apparent to those skilled in the art that various changes and modifications can be made herein without departing from the scope of the invention as defined by the appended claims.

What is claimed is:

1. A lamp comprising:
a cup-shaped body having a planar bottom with an up-standing, peripheral side wall defining a top;
a reflective coating on an inside surface of said planar bottom and side wall;
a single, side emitting LED mounted on a thermally conductive coupling positioned substantially in the center of said planar bottom;
a lens for directing a beam of light emitted from said LED in a desired direction; and
electrical connections to said LED extending through said cup-shaped body.

2. The lamp of claim 1 wherein said cup-shaped body is thermally conductive to remove heat generated by the operation of said LED from said lamp.

3. The lamp of claim 1 wherein said lens contains a Fresnel optic for spreading said beam of light generated when said LED is operating.

4. The lamp of claim 3 wherein said lens closes said top.

5. The lens of claim 3 wherein said lens is formed on said planar bottom.

6. The lamp of claim 1 wherein said lamp includes circuitry providing controlled power to said LED.

7. The lamp of claim 6 wherein said circuitry is positioned on the exterior of said cup-shaped body.
